(19) United States
(12) Patent Application Publication
(10) Pub. No.: US 2016/0353017 A1
(43) Pub. Date: Dec. 1, 2016

(54) ELECTRONIC DEVICE AND METHOD FOR PHOTOGRAPHING IMAGE

(71) Applicant: Samsung Electronics Co., Ltd., Gyeonggi-do (KR)

(72) Inventors: Dongsoo KIM, Gyeonggi-do (KR); Hwa-Young KANG, Gyeonggi-do (KR); Young-Kwon YOON, Seoul (KR); Dong-Hoon JANG, Gyeonggi-do (KR)

(73) Assignee: Samsung Electronics Co., Ltd.

(21) Appl. No.: 15/160,441

(22) Filed: May 20, 2016

(30) Foreign Application Priority Data
Jun. 1, 2015 (KR) 10-2015-0077453

(51) Int. Cl. H04N 5/232; H04N 5/265; H04N 5/262; H04N 5/225

(52) U.S. Cl. CPC H04N 5/23232; H04N 5/2257; H04N 5/265; H04N 5/2621; H04N 5/232

(57) ABSTRACT

An electronic device for photographing an image is described, which includes a lens; an image sensing module that has pixels, each of which includes a plurality of photodiodes; a lens drive module that moves the lens from a first location to a second location; and a processor that creates the image based on a first amount of received light measured by the plurality of photodiodes at the first location and a second amount of received light measured by the plurality of photodiodes at the second location.

### PRIORITY

This application claims priority under 35 U.S.C. §119(a) to Korean Application Serial No. 10-2015-0077453, which was filed in the Korean Intellectual Property Office on Jun. 1, 2015, the entire content of which is incorporated herein by reference.

### BACKGROUND

1. Field of the Disclosure

The present disclosure relates to an electronic device and, more particularly, to an electronic device and a method for photographing an image.

2. Description of the Related Art

Recently, various services and additional functions provided by electronic devices have been gradually expanded. In order to increase the effective values of the electronic devices and meet users' various demands, various applications that can be executed in the electronic devices have been developed.

Some of the applications have a camera function, and the users may photograph themselves or backgrounds using cameras equipped in the electronic devices. Further, in order to provide high-quality photographs to the users, the cameras may be equipped with lenses that have a camera-shake correction function, e.g., an optical image stabilizer (OIS) lens. Images can be photographed through two photodiodes (PDs) equipped in an image sensor of the camera, e.g., a 2PD system.

However, an image photographed using the system of two photodiodes equipped in an image sensor (the 2PD system), as described above, may have a low resolution. Although fast auto-focusing is possible and depth information can be obtained when two photodiodes are used, high resolution cannot be acquired because the two photodiodes can only make a low resolution. Furthermore, it is necessary to provide high-resolution images to users even when four or more photodiodes, as well as two photodiodes, are used.

### SUMMARY

Aspects of the present disclosure have been made to address at least the above-mentioned problems and/or disadvantages and to provide at least the advantages described below.

According to one aspect of the present disclosure, an electronic device for photographing an image is provided, including a lens; an image sensing module that has pixels, each of which includes a plurality of photodiodes; a lens drive module that moves the lens from a first location to a second location; and a processor that creates the image based on a first amount of received light measured by the plurality of photodiodes at the first location and a second amount of received light measured by the plurality of photodiodes at the second location.

According to one aspect of the present disclosure, an electronic device for photographing an image is provided, which includes a lens; a lens drive module that shifts the location of the lens; an image sensing module that has pixels, each of which includes a plurality of photodiodes; and a processor that determines the photographing mode of the electronic device to be a high-definition mode or a low-noise mode based on at least one of an intensity of illumination in a photographing environment and an indicator relating to the intensity of illumination.

According to one aspect of the present disclosure, an image photographing method is provided for an image sensing module, each pixel of which includes a plurality of photodiodes, the method including disposing a lens at a first location and measuring a first amount of received light using the plurality of photodiodes for a first period; disposing the lens at a second location and measuring a second amount of received light using the plurality of photodiodes for a second period; and creating the image based on the first amount of received light and the second amount of received light.

### BRIEF DESCRIPTION OF THE DRAWINGS

The above and other aspects, features, and advantages of certain embodiments of the present disclosure will be more apparent from the following detailed description taken in conjunction with the accompanying drawings, in which:

FIG. 1 is a schematic diagram of an electronic device according to various embodiments of the present disclosure;

FIG. 2A is a view illustrating light collecting by a lens disposed at a first location, according to various embodiments of the present disclosure;

FIG. 2B is view illustrating an example of an amount of received light when the lens is disposed at the first location, according to various embodiments of the present disclosure;

FIG. 3 is a flowchart illustrating a control method of the electronic device, according to various embodiments of the present disclosure;

FIG. 4A is a view illustrating light collecting by a lens disposed at a second location, according to various embodiments of the present disclosure;

FIG. 4B is a view illustrating an amount of received light when the lens is disposed at the second location, according to various embodiments of the present disclosure;

FIG. 5 is a flowchart illustrating a process of creating an image, according to various embodiments of the present disclosure;

FIGS. 6A and 6B are views illustrating the amount of light received by each photodiode, according to various embodiments of the present disclosure;

FIG. 7 is a flowchart illustrating a control method of the electronic device, according to various embodiments of the present disclosure;

FIGS. 8A and 8B are schematic diagrams illustrating a signal processing process in a 2PD system, according to various embodiments of the present disclosure;

FIG. 8C is a circuit diagram of a phase pixel according to various embodiments of the present disclosure;

FIG. 8D is a flowchart illustrating an operation of the electronic device, according to various embodiments of the present disclosure;

FIGS. 9A and 9B are flowcharts illustrating a method of selecting a photographing mode, according to various embodiments of the present disclosure;

FIG. 10A is a schematic diagram illustrating the configuration of an electronic device according to various embodiments of the present disclosure;

FIG. 10B is a schematic diagram of an electronic device according to various embodiments of the present disclosure;

FIG. 11 is a flowchart illustrating a control method of an electronic device, according to various embodiments of the present disclosure;

FIG. 12 is a schematic diagram illustrating a lens drive time point according to various embodiments of the present disclosure;

FIG. 13 is a schematic diagram of an electronic device according to various embodiments of the present disclosure;

FIG. 14 is a schematic diagram of an electronic device according to various embodiments of the present disclosure;

FIG. 15 is a schematic diagram of an electronic device according to various embodiments of the present disclosure; and

FIGS. 16A and 16B are schematic diagrams of an electronic device according to various embodiments of the present disclosure.

### DETAILED DESCRIPTION

The present disclosure will be described in detail using specific embodiments and the accompanying drawings. However, it should be understood that the present disclosure is not limited to the specific embodiments, but the present disclosure includes all modifications, equivalents, and alternatives within the spirit and the scope of the present disclosure.

Although ordinal numbers such as first, second, etc. may be used for describing various elements, the structural elements are not restricted by the terms. The terms are used merely for the purpose to distinguish an element from the other elements. For example, a first element may be referred to as a second element, and similarly, a second element may also be referred to as a first element without departing from the scope of the present disclosure. As used herein, the term “and/or” includes any and all combinations of one or more associated items.

In the present disclosure, the terms are used to describe specific embodiments, and are not intended to limit the present disclosure. As used herein, the singular forms are intended to include the plural forms as well, unless the context clearly indicates otherwise. In the present disclosure, the terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

Unless defined differently, all terms used herein, which include technical terminologies or scientific terminologies, have the same meaning as that understood by a person skilled in the art to which the present disclosure belongs. It should be interpreted that the terms, which are identical to those defined in general dictionaries, have the meaning identical to that in the context of the related technique. The terms should not be ideally or excessively interpreted according to their formal meanings.

In describing the present disclosure below, a detailed description of related known configurations or functions incorporated herein will be omitted when it is determined that the detailed description thereof may unnecessarily obscure the subject matter of the present disclosure. The terms which will be described below are terms defined in consideration of the functions in the present disclosure, and may be different according to users, intentions of the users, or customs. Therefore, the definition should be made based on the overall contents of the present specification.

According to the present disclosure, a higher-resolution image can be provided even though two photodiodes are used, and a high-resolution image can be provided to a user even when four or more photodiodes are used.

In addition, by moving a lens in at least one of the four directions (up, down, left, and right), embodiments according to the present disclosure can reduce image noise when an image is photographed in an environment in which the amount of light is relatively small, and can enhance image resolution when an image is photographed in an environment in which the amount of light is sufficient.

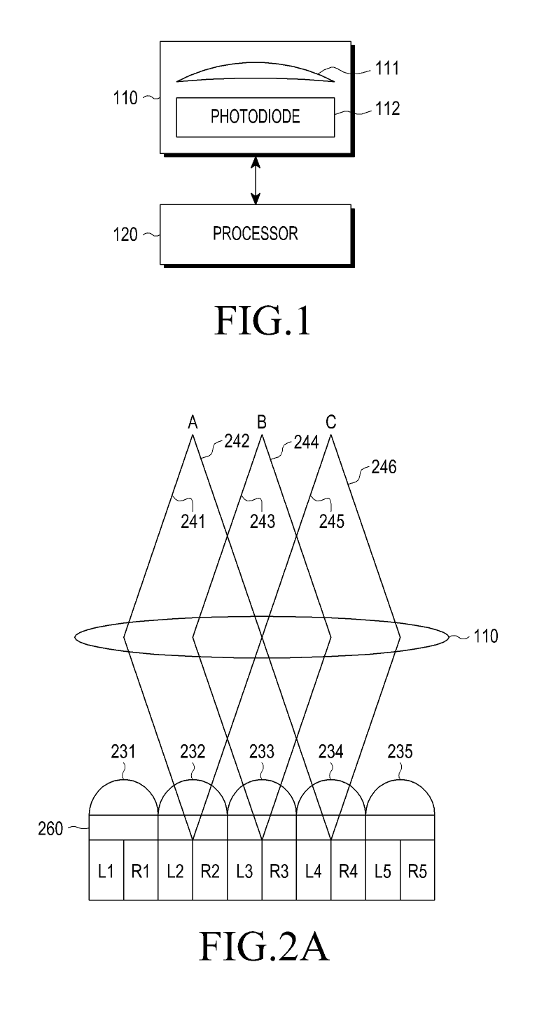

FIG. 1 is a schematic diagram of an electronic device according to various embodiments of the present disclosure.

As illustrated in FIG. 1, the electronic device may include a camera module 110 and a processor 120.

The camera module 110 may include at least one of a body tube for the zoom in/zoom out function of at least one camera, a motor that controls the movement of the body tube for the zoom in/zoom out function of the body tube, and a flash that provides a light source for photographing. The camera module 110 may acquire a video or image input through a lens 111 by using a photodiode 112. The camera module 110 may acquire a video or image in units of frames, and the acquired video or image may be displayed on a display unit under the control of the processor 120. A user may photograph a video or image through the camera module 110.

The processor 120 may include one or more of a Central Processing Unit (CPU), an Application Processor (AP), and a Communication Processor (CP). For example, the processor 120 may control one or more other elements of the electronic device and/or may carry out operations or data processing that is associated with communication. The processor 120 may be referred to as a controller, or may include a controller as a part thereof.

The processor 120 may drive the movement of at least one lens 111 in the camera module 110. The camera module 110 may include an actuator that can drive the movement of at least one lens 111. Alternatively, the electronic device may include an actuator that can drive the movement of at least one lens 111. The processor 120 may output an actuator drive signal to drive the movement of the lens 111.

Meanwhile, in the various embodiments of the present disclosure, the photodiode 112 may include at least one photodiode pair. Different light beams may be incident on the photodiode pair. For example, it is assumed that the photodiode pair includes a left photodiode and a right photodiode. In this case, the first light may be incident on the left photodiode, and the second light may be incident on the right photodiode. Here, the first light may be light that travels from a point outside the electronic device through a first path, and the second light may be light that travels from the point outside the electronic device through a second path. The first and second paths may differ from each other. Accordingly, the electronic device or the processor 120 may measure the amounts of received light for the light beams from the point through the different paths. For example, the electronic device or the processor 120 may acquire the first amount of received light that is measured by the left photodiode and the second amount of received light that is measured by the right photodiode. The electronic device or the processor 120 may determine depth information on the basis of the first amount of received light and the second amount of received light. In addition, the electronic device or the processor 120 may also determine brightness information of the light on the basis of the first amount of received light and the second amount of received light. The photodiode pair may also be referred to as a phase pixel or a two-photodiode (2PD) system according to implementation. By these means, the electronic device or the processor 120 may acquire an image having a high resolution through a single measurement.

The processor 120 may shift the location of the lens 111. For example, the processor 120 may control the lens 111 to collect light at a first location for a first period of time and collect light at a second location for a second period of time. Accordingly, the processor 120 may acquire information on the amount of received light at the first location and may acquire information on the amount of received light at the second location. The processor 120 may acquire an image having a resolution of b on the basis of the amount of received light at the first location and the amount of received light at the second location. For example, the resolution of b may be two times the resolution of a. The processor 120 may acquire the image having a double resolution on the basis of information on the amount of received light at the first location and information on the amount of received light at the shifted second location, as will be described in more detail below.

According to the above description, in cases where the lens collects light at multiple locations, the electronic device or the processor 120 may acquire multiple images for the respective locations. The electronic device or the processor 120 may acquire an image having a first resolution by using the multiple images. The first resolution may correspond to the number of photodiodes. For example, in cases where the number of photodiodes is c and the number of pairs of a 2PD system is c/2, the first resolution may be c. The electronic device or the processor 120 may simultaneously acquire phase information (e.g., depth information) by the 2PD system and the image having the first resolution, thereby solving a problem that a resolution is half the total number of photodiodes in an existing 2PD system.

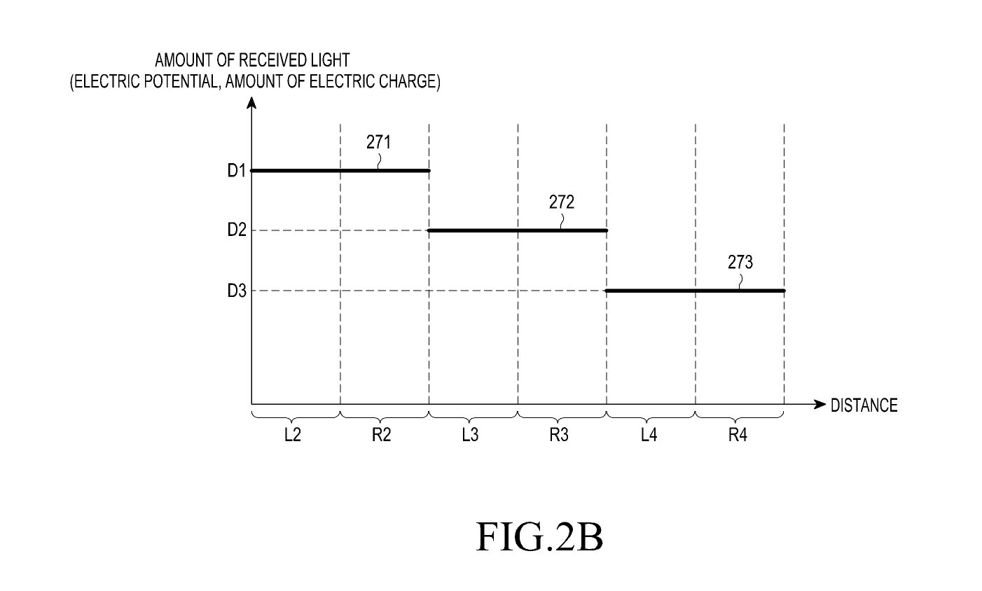

FIG. 2A is a view illustrating light collecting when the lens is disposed at a first location, according to various embodiments of the present disclosure.

As illustrated in FIG. 2A, the lens 110 collects a plurality of light beams 241 to 246 incident thereon. The lens 110 collects a plurality of light beams 241 and 242 from point A through different paths, a plurality of light beams 243 and 244 from point B through different paths, and a plurality of light beams 245 and 246 from point C through different paths. The electronic device or the processor 120 operates to dispose the lens 110 at the first location for a first period of time. For example, the electronic device or the processor 120 may output an actuator drive signal to control the lens 110 to be disposed at the first location.

The electronic device includes micro-lenses 231 to 235. The micro-lenses 231 to 235 are disposed to correspond to photodiode pairs. For example, the first micro-lens 231 is disposed on the first left photodiode L1 and the first right photodiode R1. Each of the micro-lenses 231 to 235 re-collects the light collected by the lens 110 and makes the re-collected light input to the first left photodiode L1 and the first right photodiode R1. For example, the first light 241 from point A is refracted and input to the second left photodiode L2 by the lens 110 and the second micro-lens 232.

The alignment between the lens 110 and the micro-lenses 231 to 235 in FIG. 2A is merely illustrative, and any alignment by which light from one point through different paths can be input to the photodiode pairs of the 2PD system may be used without limitation. Further, it is merely illustrative that the electronic device includes the micro-lenses 231 to 235, and the electronic device, according to the various embodiments of the present disclosure, may also make light from one point through different paths input to the photodiode pairs of the 2PD system by collecting the light using the lens 110. Similarly to the above, the second light 242 from point A may be input to the second right photodiode R2. The third light 243 and the fourth light 244 from point B may be input to the third left photodiode L3 and the third right photodiode R3, respectively. The fifth light 245 and the sixth light 246 from point C may be input to the fourth left photodiode L4 and the fourth right photodiode R4, respectively.

The electronic device further includes color filters 260 on the photodiodes. The color filter on the first photodiode pair (L1, R1) and the color filter on the second photodiode pair (L2, R2) may filter different colors. Accordingly, the electronic device may acquire information on the amounts of light for a plurality of different colors.

FIG. 2B is a view illustrating an example of an amount of received light when the lens is disposed in the first location, according to various embodiments of the present disclosure. FIG. 2B shows the amounts of received light of the photodiodes L2, R2, L3, R3, L4, and R4 in the alignment situation of FIG. 2A.

The electronic device measures the amount of received light 271 having a first magnitude D1 through the second photodiode pair (L2, R2). Here, the amount of received light has an indicator capable of representing the amount of received light, for example, a unit of electrical potential V or an amount of electrical charge A. Each of the photodiodes converts the incident light into an electrical signal, and the amount of received light is proportional to an electrical potential or an amount of electrical charge. Namely, the first magnitude D1 corresponds to an electrical potential or an amount of electrical charge. The electronic device may measure the amount of received light 272 having a second magnitude D2 through the third photodiode pair (L3, R3). The electronic device may measure the amount of received light 273 having a third magnitude D3 through the fourth photodiode pair (L4, R4). In the 2PD system, the sum of information on the amount of received light from a left photodiode and information on the amount of received light from a right photodiode is processed as information on the amount of received light that corresponds to the left and right photodiodes. Accordingly, the second photodiode pair (L2, R2) measures the amount of received light having the same magnitude D1.

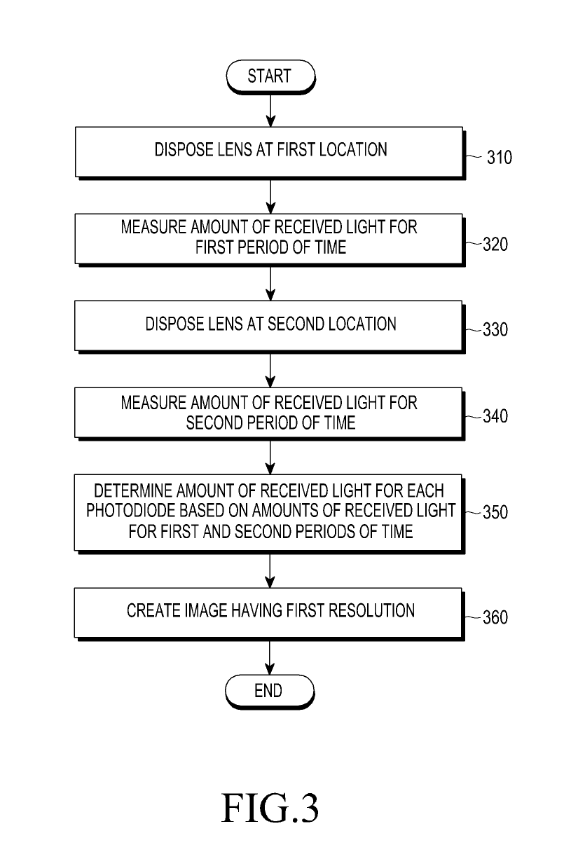

FIG. 3 is a flowchart illustrating a control method of the electronic device, according to various embodiments of the present disclosure.

In step 310, the electronic device disposes the lens 110 at a first location. For example, the electronic device may output an actuator drive signal to dispose the lens 110 at the first location. In step 320, the electronic device measures the amount of received light for a first period of time. The electronic device measures the amounts of received light that are measured by the photodiode pairs in order to measure the amount of received light for the first period of time. Here, the first period of time may be set according to the intensity of illumination in the photographing environment, or may be preset.

In step 330, the electronic device disposes the lens 110 at a second location. For example, the electronic device may output an actuator drive signal to move the lens 110 from the first location to the second location. In one embodiment, the electronic device moves the lens 110 to correspond to the length of the photodiode. In step 340, the electronic device measures the amount of received light for a second period of time. The electronic device measures the amounts of received light that are measured by the photodiode pairs in order to measure the amount of received light for the second period of time. Here, the second period of time may be set according to the intensity of illumination in the photographing environment, or may be preset.

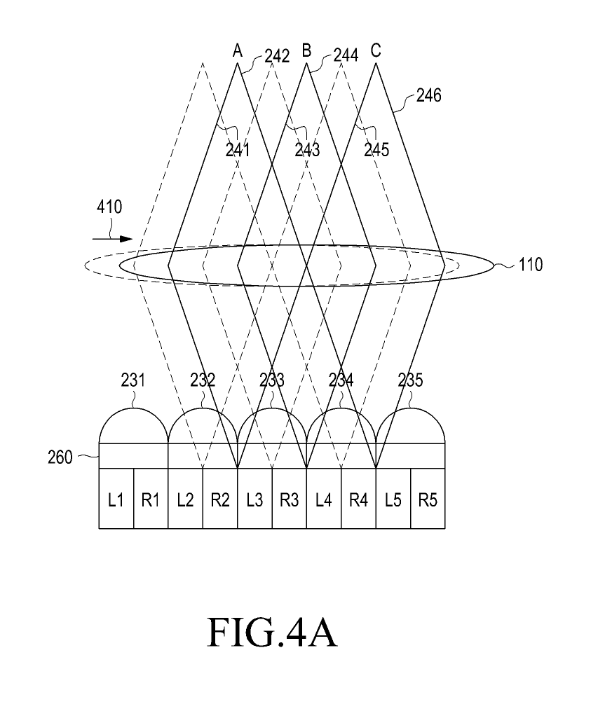

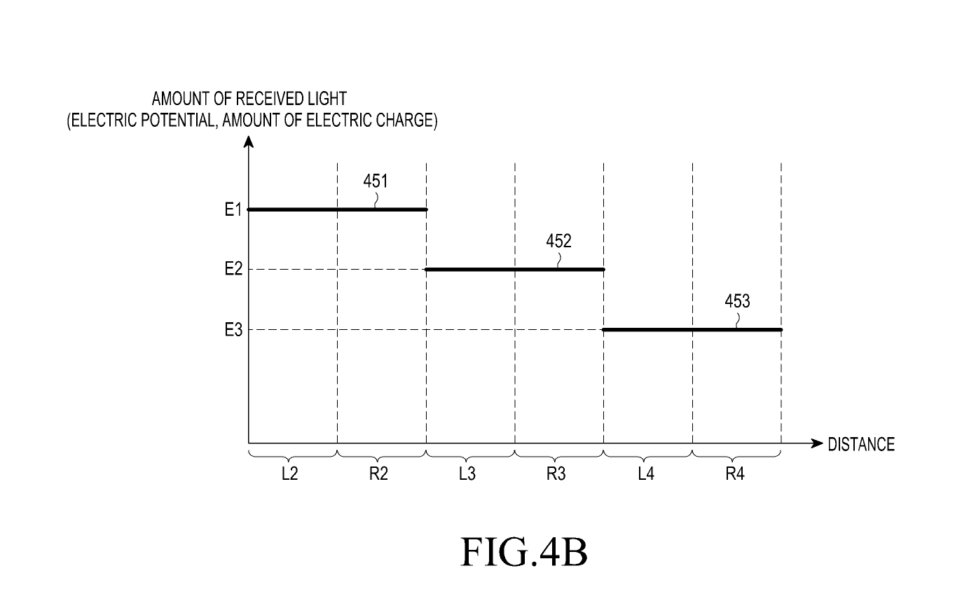

In step 350, the electronic device determines the amount of received light for each photodiode on the basis of the amount of received light for the first period of time and the amount of received light for the second period of time. In one embodiment, the electronic device may shift one of the amount of received light for the first period of time and the amount of received light for the second period of time. The electronic device may determine the amount of received light for each photodiode on the basis of the sum of the other amounts of received light and the amount of received light that has been shifted. In step 360, the electronic device or the processor may create an image having a first resolution based on the amount of received light for each photodiode. For example, the first resolution may be equal to the total number of photodiodes rather than the number of photodiode pairs. According to the implementation, the electronic device may create the image having the first resolution by adding a first image that corresponds to the amount of received light for the first period of time and a second image corresponds to the amount of received light for the second period of time. The determining of the amount of received light for each photodiode will be described below in more detail with reference to FIGS. 4A, 4B, 5, 6A, and 6B.

FIG. 4A is a view illustrating light collecting by a lens disposed at the second location, according to various embodiments of the present disclosure.

As illustrated in FIG. 4A, the electronic device or the processor moves the lens 110 from the first location to the second location in the direction of the arrow indicated by reference numeral 410. The amount of movement 410 may correspond to, but is not limited to, for example, the length of the photodiode. Due to the movement 410 of the lens 110, light incident on each photodiode differs from that when the lens 110 is disposed at the first location. More specifically, the first light 241 and the second light 242 from point A are input to the second right photodiode R2 and the third left photodiode L3, respectively. In addition, the third light 243 and the fourth light 244 from point B are input to the third right photodiode R3 and the fourth left photodiode L4, respectively. Further, the fifth light 245 and the sixth light 246 from point C are input to the fourth right photodiode R4 and the fifth left photodiode L5, respectively. Namely, with the movement 410 of the lens 110 in the first direction, the light incident on each photodiode is also shifted in the first direction.

FIG. 4B is a view illustrating an amount of received light when the lens is disposed at the second location, according to various embodiments of the present disclosure.

The electronic device measures the amount of received light 451 having a first magnitude E1 through the second photodiode pair (L2, R2). Here, the amount of received light has an indicator capable of representing the amount of received light, for example, a unit of electrical potential V or an amount of electrical charge A. Each of the photodiodes converts the incident light into an electrical signal, and the amount of received light is proportional to an electrical potential or an amount of electrical charge. Namely, the first magnitude E1 corresponds to an electrical potential or an amount of electrical charge. The amount E1 of received light of the second photodiode pair (L2, R2) when the lens 110 is disposed at the second location may differ from the amount D1 of received light thereof when the lens 110 is disposed at the first location. This is caused by the shift of the light according to the change in the location of the lens 110. The electronic device measures the amount of received light 452 having a second magnitude E2 through the third photodiode pair (L3, R3). The electronic device measures the amount of received light 453 having a third magnitude E3 through the fourth photodiode pair (L4, R4). In the 2PD system, the sum of information on the amount of received light from a left photodiode and information on the amount of received light from a right photodiode may be processed as information on the amount of received light that corresponds to the left and right photodiodes. Accordingly, the second photodiode pair (L2, R2) measures the amount of received light having the same magnitude E1.

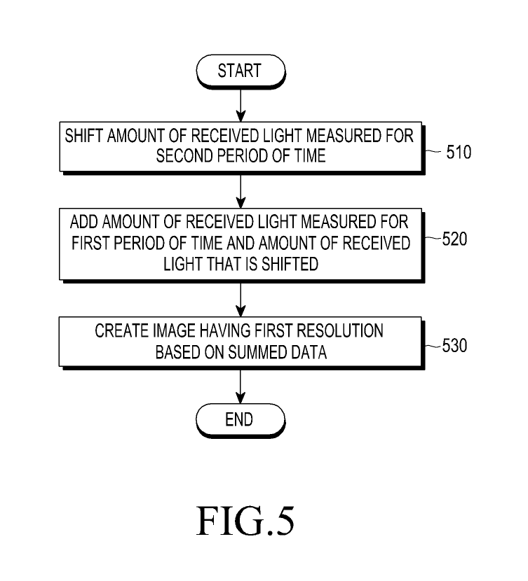

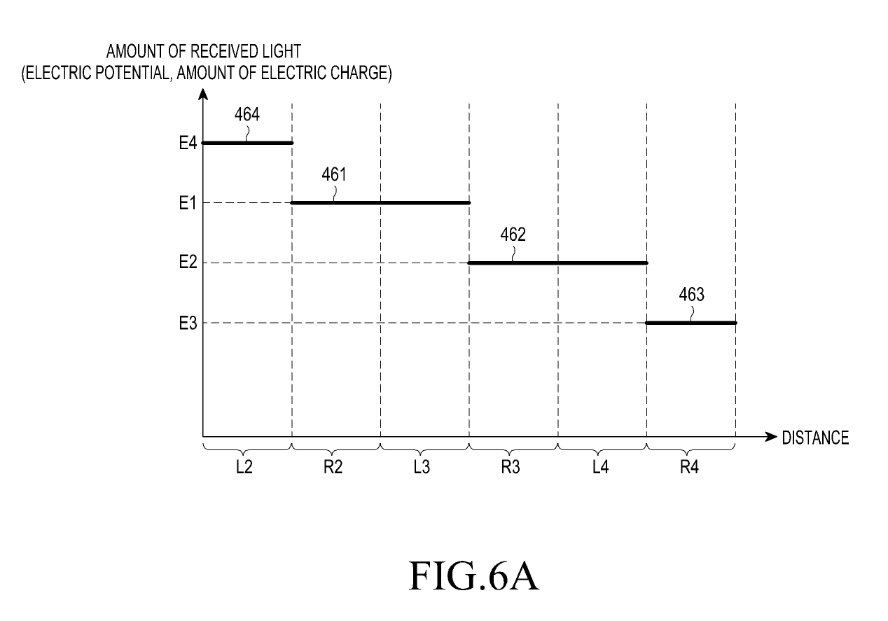

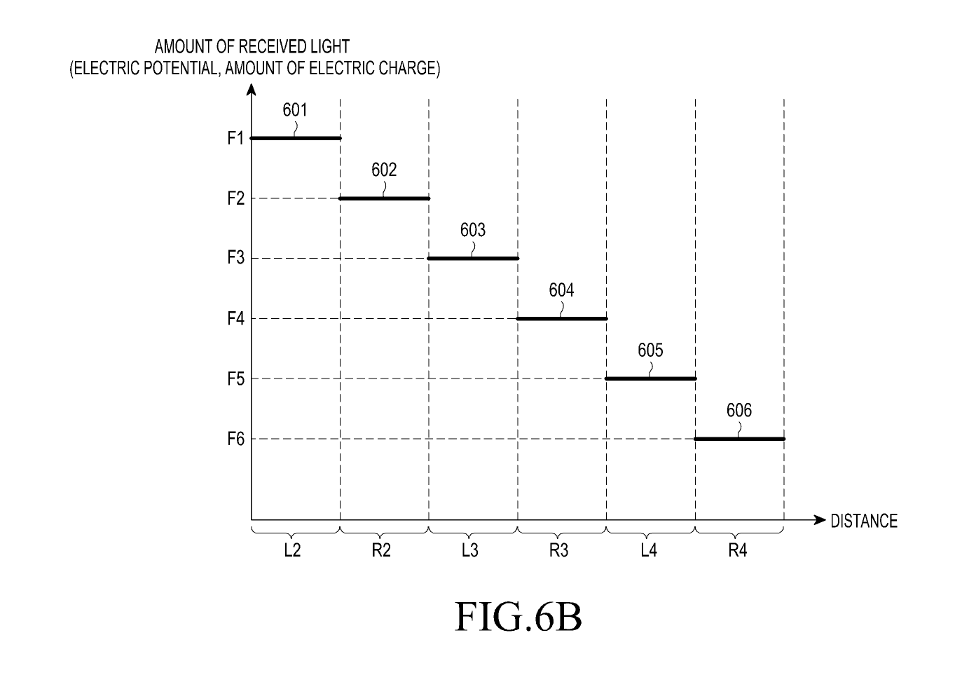

FIG. 5 is a flowchart illustrating a process of creating an image, according to various embodiments of the present disclosure. The embodiment of FIG. 5 will be described in more detail with reference to FIGS. 6A and 6B. FIGS. 6A and 6B are views illustrating the an amount of received light for each photodiode, according to various embodiments of the present disclosure.

In step 510, the electronic device or the processor 120 shifts the amount of received light that has been measured for the second period of time. FIG. 6A is the result obtained by shifting the amount of received light that has been measured for the second period of time (for example, the amount of received light illustrated in FIG. 4B) by the electronic device or the processor 120, according to various embodiments of the present disclosure. In one embodiment, the electronic device or the processor 120 shifts the amount of received light E1 451, which corresponds to the second photodiode pair (L2, R2) in FIG. 4, by the length of the photodiode as illustrated in FIG. 6A. Accordingly, the electronic device or the processor 120 determines the amount of received light 461 that corresponds to the second right photodiode R2 and the third left photodiode L3 to be E1. In addition, the electronic device or the processor 120 determines the amount of received light 462 that corresponds to the third right photodiode R3 and the fourth left photodiode L4 to be E2. The electronic device or the processor 120 determines the amount of received light 463 that corresponds to the fourth right photodiode R4 to be E3. The electronic device or the processor 120 determines the amount of received light 464 that corresponds to the second left photodiode L2 to be E4, which corresponds to the amount of received light of the first photodiode pair.

In step 520, the electronic device or the processor 120 adds the amount of received light that has been measured for the first period of time and the amount of received light that has been measured for the second period of time when the lens is shifted. In step 530, the electronic device or the processor 120 creates an image having a first resolution on the basis of the summed data. The first resolution is equal to the total number of photodiodes rather than the number of photodiode pairs.

In one embodiment, as illustrated in FIG. 6B, the electronic device or the processor 120 determines data obtained by adding the amount of received light that has been measured for the first period of time as illustrated in FIG. 2B and the amount of received light for the second period of time that has been shifted as illustrated in FIG. 6A. In particular, referring to the third left photodiode L3, the amount of received light that corresponds to the third left photodiode L3 in FIG. 2B is D2, and the amount of received light that corresponds to the third left photodiode L3 in FIG. 6A is E1. Accordingly, the magnitude of the summed data 602 that corresponds to the third left photodiode L3 is F2 (=D2+E1). Furthermore, referring to the third right photodiode R3, the amount of received light that corresponds to the third right photodiode R3 in FIG. 2B is D2, and the amount of received light that corresponds to the third right photodiode R3 in FIG. 6A is E2. Accordingly, the magnitude of the summed data 603 that corresponds to the third right photodiode R3 is F3 (=D2+E2). Namely, the amounts of received light 603 and 604 that correspond to the third left photodiode L3 and the third right photodiode R3, respectively, which constitute the third photodiode pair (L3, R3), may differ from each other. In addition, the amounts of received light 605 and 606 that correspond to the fourth left photodiode L4 and the fourth right photodiode R4, respectively, which constitute the fourth photodiode pair (L4, R4), may differ from each other. Accordingly, the amounts of received light 601 to 606 that correspond to the respect photodiodes may differ from each other, and the amount of received light for each photodiode may be measured. The electronic device or the processor 120 may create an image based on the summed data. Since the amounts of received light for the respective photodiodes differ from each other, the electronic device or the processor 120 may create an image that has a resolution that corresponds to the number of photodiodes.

Although the configuration of creating the summed data by shifting the data during the second period of time has been described in the above process, this is merely illustrative, and there is no limitation on a target to be shifted.

In addition, the electronic device or the processor 120 may also acquire phase information, such as depth information, on the basis of the 2PD system processing result, namely, a difference in the actual amounts of received light in a photodiode pair. That is, the electronic device, according to the various embodiments of the present disclosure, may acquire an image having a resolution that corresponds to the number of photodiodes through an additional analysis while acquiring phase information, such as depth information, by maintaining the algorithm of the 2PD system. Accordingly, an image having a resolution two times higher than that in an existing 2PD system may be acquired.

Meanwhile, the embodiment in which the location of the lens 110 is shifted in the first direction, for example, to the right has been described above, but there is no limitation on the first direction. Namely, in the various embodiments of the present disclosure, the electronic device may move the lens 110 in at least one of the four directions (up, down, left, and right). In addition, although the phase pixel of the 2PD system has been described above, there is no limitation on the type of phase pixel, and the embodiment of the present disclosure may also be applied to a 4PD system. In the 4PD system, the electronic device may move the lens 110 to four locations and may measure the amount of received light at each location. The electronic device may create a high-definition image based on the sum of the amounts of received light that are measured at the four locations or the sum of data obtained by shifting some of the amounts of received light that are measured.

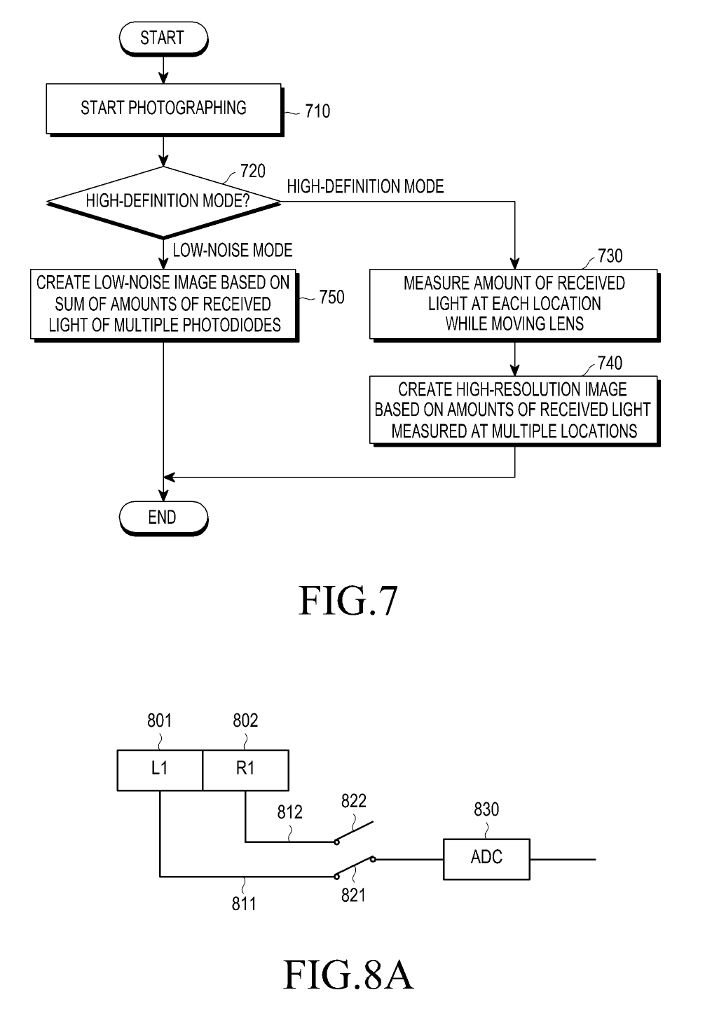

FIG. 7 is a flowchart illustrating a control method of the electronic device, according to various embodiments of the present disclosure.

In step 710, the electronic device starts photographing. In step 720, the electronic device identifies whether the photographing mode is a high-definition mode or a low-noise mode. The electronic device or the processor 120 determines the photographing mode to be one of the high-definition mode and the low-noise mode based on the intensity of illumination of the photographing environment. Alternatively, the electronic device or the processor 120 may determine the photographing mode to be one of the high-definition mode and the low-noise mode based on at least one of the indicators relating to the intensity of illumination, for example, an exposure value of an image sensing module and a gain setting value. Here, the indicators relating to the intensity of illumination, for example, the exposure value of the image sensing module and the gain setting value may be changed by, and may be associated with, the intensity of illumination.

In one embodiment, the electronic device or the processor 120 may determine the photographing mode based on the intensity of illumination in the photographing environment. For example, in a case where the intensity of illumination exceeds a first threshold value, the electronic device or the processor 120 may determine the photographing mode to be the high-definition mode. In a case where the intensity of illumination is less than or equal to the first threshold value, the electronic device or the processor 120 may determine the photographing mode to be the low-noise mode. Alternatively, the electronic device or the processor 120 may determine the photographing mode based on the exposure value. For example, in a case where the exposure value exceeds a second threshold value, the electronic device or the processor 120 may determine the photographing mode to be the high-definition mode. In a case where the exposure value is less than or equal to the second threshold value, the electronic device or the processor 120 may determine the photographing mode to be the low-noise mode. Alternatively, the electronic device or the processor 120 may determine the photographing mode based on a gain value. For example, in a case where the gain value exceeds a third threshold value, the electronic device or the processor 120 may determine the photographing mode to be the high-definition mode. In a case where the gain value is less than or equal to the third threshold value, the electronic device or the processor 120 may determine the photographing mode to be the low-noise mode.

In a case where the photographing mode is determined to be the high-definition mode, the electronic device or the processor 120 moves the lens and may measure the amount of received light at each location in step 730. For example, the electronic device or the processor 120 may measure the amount of received light at a plurality of locations (e.g., first and second locations) as illustrated in FIGS. 2A and 4A. In step 740, the electronic device or the processor 120 creates a high-resolution image based on the amounts of received light that have been measured at the plurality of locations. Here, the high-resolution image may correspond to the number of photodiodes and may have a resolution higher than that of a low-resolution image that corresponds to the number of photodiode pairs. The electronic device or the processor 120 may create a high-definition image based on the sum of the amounts of received light that have been measured at the plurality of locations, or the sum of data obtained by shifting some of the amounts of received light that are measured.

Meanwhile, in a case where the photographing mode is determined to be the low-noise mode, the electronic device or the processor 120 creates a low-noise image based on the sum of the amounts of received light of the plurality of photodiodes in step 750. More specifically, the electronic device or the processor 120 may add and process the amounts of received light (for example, amounts of electrical charge, or currents) from the plurality of photodiodes that constitute the photodiode pairs. An existing 2PD system may perform Analog to Digital Conversion (ADC) a total of two times by processing the amount of received light from one photodiode that constitutes a photodiode pair (for example, performing ADC on the same) and processing the amount of received light from the other photodiode that constitutes the photodiode pair (for example, performing ADC on the same). When the ADC is performed, a quantizing noise may be generated. Accordingly, in the case of the existing 2PD system, a quantizing noise may be generated twice, and a problem in a photographing environment with a low intensity of illumination may be made worse.

The electronic device or the processor 120, according to the various embodiments of the present disclosure, may add the amounts of received light from photodiodes that constitute a phase pixel of a 2PD or 4PD system and may perform processing (for example, ADC) once, thereby reducing noise generated during the processing, such as a quantizing noise.

In the various embodiments of the present disclosure, the electronic device may differently control the movement of the lens according to a photographing mode. For example, in a low-noise mode, the electronic device may move the lens for an OIS control, such as camera-shake correction. Namely, in the low-noise mode, the electronic device may control the lens with a first movement. Meanwhile, in a high-definition mode, the electronic device may move the lens to a plurality of locations as described above. Further, in the high-definition mode, the electronic device may additionally move the lens for an OIS control while moving the lens to the plurality of locations. Namely, in the high-definition mode, the electronic device may control the lens with a second movement.

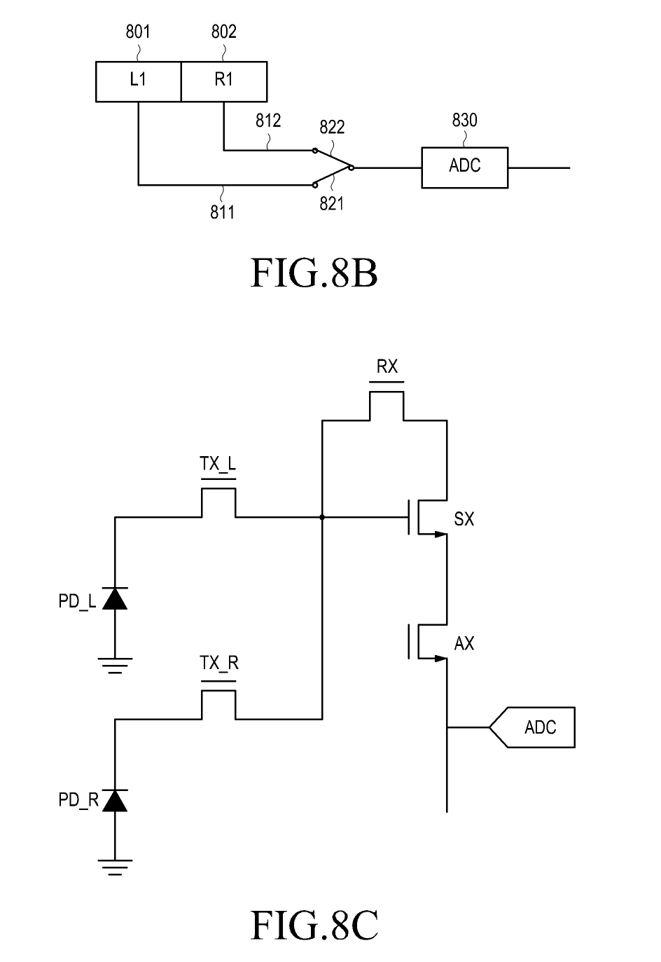

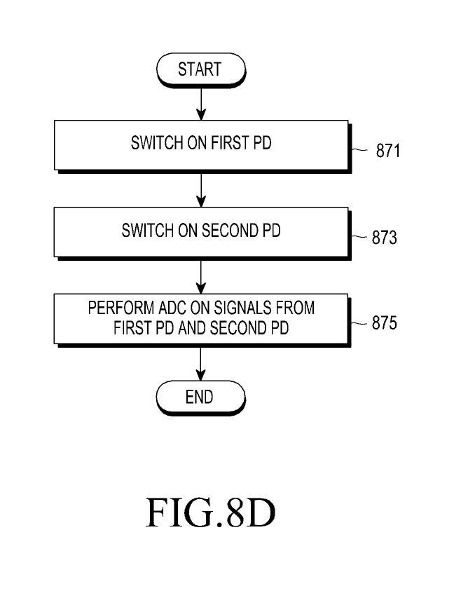

Hereinafter, the low-noise mode will be described in more detail with reference to FIGS. 8A to 8D.

FIG. 8A is a schematic diagram illustrating a signal processing process in a 2PD system, according to various embodiments of the present disclosure. A phase pixel that includes the 2PD system includes left photodiode L1 801 and right photodiode R1 802. As described above with reference to FIG. 2A, the left photodiode 801 receives light input through a first path and converts the light into an electrical signal 811 to output the converted electrical signal. The right photodiode 802 receives light input through a second path and converts the light into an electrical signal 812 to output the converted electrical signal. A first switch 821 is disposed between the left photodiode 801 and an ADC 830, and a second switch 822 is disposed between the right photodiode 802 and the ADC 830. In a high-definition mode, the electronic device turns on the first switch 821 first and performs ADC on the electrical signal 811 from the left photodiode 801. Thereafter, the electronic device turns off the first switch and turns on the second switch to perform ADC on the electrical signal 812 from the right photodiode 802. The electronic device acquires phase information, such as depth information, based on a difference between the electrical signal 811 from the left photodiode 801 and the electrical signal 812 from the right photodiode 802. In addition, as described above, the electronic device may sequentially turn on the first and second switches again after shifting the location of the lens 110, measure the amount of received light while moving the lens to a plurality of locations, and create a high-definition image based on the amounts of received light that are measured at the plurality of locations. In this case, the ADC is performed twice, but noise may not be dominant on account of a relatively high illuminance environment.

When in a low-noise mode, the electronic device simultaneously turns on the first and second switches 821 and 822 as illustrated in FIG. 8B. Since the first and second switches 821 and 822 are simultaneously turned on, the electrical signal 811 from the left photodiode 801 and the electrical signal 812 from the right photodiode 802 are simultaneously converted by the ADC 830. Accordingly, the converting is performed once, and a quantizing noise is lower than that in a high-definition mode. In particular, a low-noise image that has low noise even in a low-illuminance environment may be acquired.

Meanwhile, in a 4PD system, the electronic device may simultaneously perform ADC on electrical signals from four photodiodes that constitute a pixel.

FIG. 8C is a circuit diagram of a phase pixel according to various embodiments of the present disclosure.

Each of unit pixels of an image sensor may include photoelectric conversion diodes PD_L and PD_R, transfer transistors TX_L and TX_R, a source follower transistor SX, a reset transistor RX, and a selection transistor AX.

The transfer transistors TX_L and TX_R, the source follower transistor SX, the reset transistor RX, and the selection transistor AX may include a transfer gate (TG), a source follower gate (SF), a reset gate (RG), and a selection gate (SEL), respectively. The photoelectric conversion diodes PD_L and PD_R may be photodiodes that include a N-type impurity region and a P-type impurity region. The drain of each of the transfer transistors TX_L and TX_R may be construed as a Floating Diffusion (FD) region. The FD region may be a source of the reset transistor RX. The FD region may be electrically connected to the source follower gate SF of the source follower transistor SX. The source follower transistor SX is connected to the selection transistor AX. The reset transistor RX, the source follower transistor SX, and the selection transistor AX may be shared by the plurality of diodes PD_L and PD_R within the pixel, or by adjacent pixels, which makes it possible to enhance the degree of integration.

In the circuit diagram, first, residual electrical charges in the FD region may be discharged by applying a power supply voltage VDD to the drain of the reset transistor RX and the drain of the source follower transistor SX and turning on the reset transistor RX while light is blocked. Thereafter, when the reset transistor RX is turned off and external light is incident on the photoelectric conversion diodes PD_L and PD_R, electron-hole pairs may be generated in the photoelectric conversion diodes PD_L and PD_R. The holes may move to the P-type impurity implanted region and may be accumulated therein, and the electrons may move to the N-type impurity implanted region and may be accumulated therein. When the transfer transistors TX_L and TX_R are turned on, electrical charges, such as the electrons, may be transferred to the FD region and may be accumulated therein. In particular, in a low-noise mode, the transfer transistors TX_L and TX_R may be simultaneously turned on, and electrical signals from the photoelectric conversion diodes PD_L and PD_R may be simultaneously input to the ADC 830. The ADC 830 may perform ADC once by the electrical signals. The gate bias of the source follower transistor SX changes in proportion to the amount of accumulated electrical charges to cause a change in the source potential of the source follower transistor SX. In this case, when the selection transistor AX is turned on, a signal caused by an electrical charge is read through a column line. In a low-noise mode, the electronic device of the present disclosure may add the amounts of electrical charge acquired by photodiodes and may acquire an image through the sum of the amounts of electrical charge.

FIG. 8D is a flowchart illustrating an operation of the electronic device, according to various embodiments of the present disclosure.

In step 871, the electronic device turns on the first switch that connects a first diode and the processing module that includes an ADC. In step 873, the electronic device turns on the second switch that connects the second photodiode and the processing module that includes the ADC. Here, the first and second diodes may be photodiodes that constitute a phase pixel. In addition, the electronic device may control the switches to simultaneously connect the first and second photodiodes to the processing module that includes the ADC.

In step 875, the electronic device performs ADC on signals from the first and second photodiodes. The electronic device may perform processing once by adding the electrical signals (i.e., the amounts of electrical charge) from the first and second photodiodes and performing the ADC thereon. Accordingly, it is possible to reduce noise, including a quantizing noise due to ADC, which is generated during the processing, thereby acquiring an image that is resistant to noise even in a low-illuminance environment.

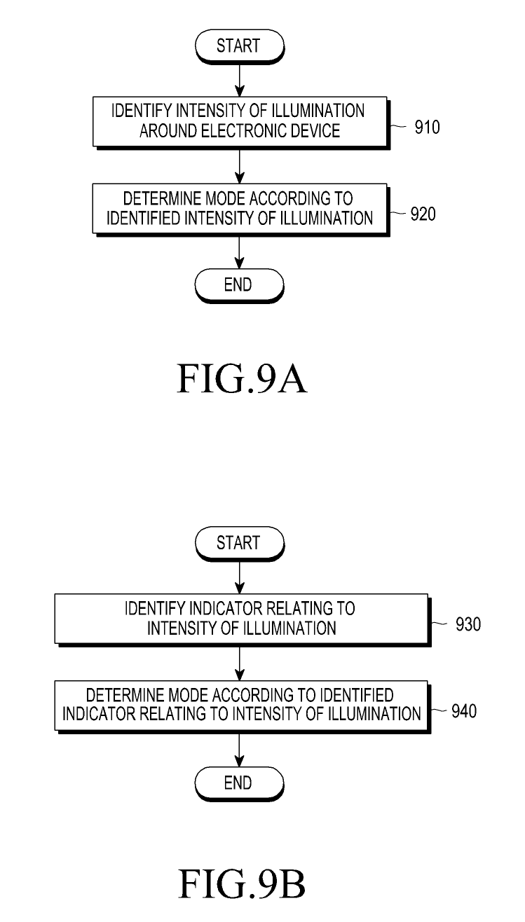

FIGS. 9A and 9B are flowcharts illustrating a method of selecting a photographing mode, according to various embodiments of the present disclosure.

Referring to FIG. 9A, in step 910, the electronic device or the processor 120 identifies the intensity of illumination around the electronic device. The electronic device or the processor 120 may identify the intensity of illumination by measuring the amount of electrical charge or electrical potential that is measured by a photodiode. In step 920, the electronic device or the processor 120 determines the photographing mode according to the identified intensity of illumination. For example, in a case where the intensity of illumination exceeds a first threshold value, the electronic device or the processor 120 may determine the photographing mode to be a high-definition mode. In a case where the intensity of illumination is less than or equal to the first threshold value, the electronic device or the processor 120 may determine the photographing mode to be a low-noise mode.

Referring to FIG. 9B, in step 930, the electronic device or the processor 120 identifies an indicator relating to the intensity of illumination. The indicator relating to the intensity of illumination is an indicator affected by the intensity of illumination, and may include at least one of, for example, an exposure value and a gain value. In step 940, the electronic device or the processor 120 determines the photographing mode based on the indicator, which may be, for example, the exposure value. For example, in a case where the exposure value exceeds a second threshold value, the electronic device or the processor 120 may determine the photographing mode to be a high-definition mode. In a case where the exposure value is less than or equal to the second threshold value, the electronic device or the processor 120 may determine the photographing mode to be a low-noise mode. Alternatively, the electronic device or the processor 120 may determine the photographing mode based on the gain value. For example, in a case where the gain value exceeds a third threshold value, the electronic device or the processor 120 may determine the photographing mode to be a high-definition mode. In a case where the gain value is less than or equal to the third threshold value, the electronic device or the processor 120 may determine the photographing mode to be a low-noise mode.

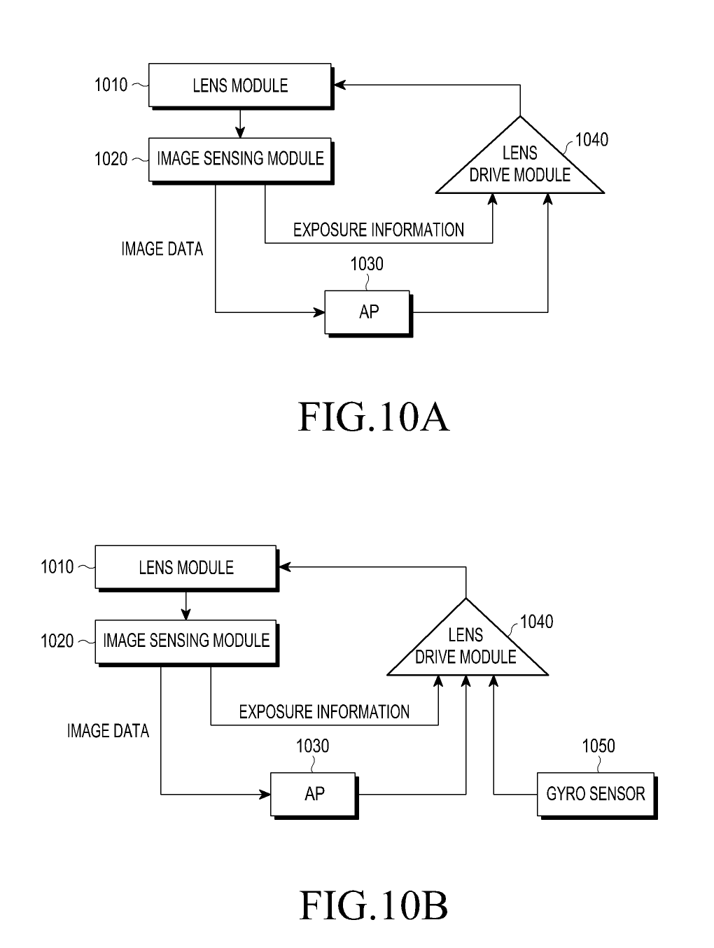

FIG. 10A is a schematic diagram illustrating the configuration of an electronic device according to various embodiments of the present disclosure.

The electronic device includes a lens module 1010, an image sensing module 1020, an AP 1030, and a lens drive module 1040.

The lens module 1010 may include a lens and an actuator for driving the lens. For example, the actuator may be driven based on a drive signal from the lens drive module 1040. The lens drive module 1040 may output the drive signal to the lens module 1010 under the control of the AP 1030.

The image sensing module 1020 outputs exposure information to the lens drive module 1040. The exposure information may include timing information on a period for which electrical charge output from a photodiode is accumulated, the time when the period starts, and the time when the period ends.

The lens drive module 1040 outputs a drive signal to the lens module 1010 according to the input exposure information. As described above, the electronic device, according to the various embodiments of the present disclosure, may move the lens to a plurality of locations and may acquire a high-definition image based on the amount of received light at each location. However, if the lens moves for the period during which the electrical charge output from the photodiode is accumulated, an appropriate amount of electrical charge may not be accumulated for the corresponding period so that the image fails to reflect a sufficient amount of light. Accordingly, the image sensing module 1020, according to the various embodiments of the present disclosure, outputs the exposure information to the lens drive module 1040, and the lens drive module 1040 drives the lens module 1010 based on the exposure information of the image sensing module 1020. More specifically, based on the exposure information, the lens drive module 1040 drives the lens module 1010 for a period during which accumulated electrical charges are read. Namely, a high-definition image in which a sufficient amount of light is reflected may be acquired by virtue of interworking between the movement of the lens and the exposure/read time of the image sensing module 1020.

The image sensing module 1020 outputs image data to the AP 1030, and the AP 1030 creates an image based on the image data. More specifically, in a case where the lens is shifted to a plurality of locations, the AP 1030 may create an image based on image data that corresponds to the locations.

FIG. 10B is a schematic diagram of an electronic device according to various embodiments of the present disclosure. Here, a lens module 1010 may include an OIS lens and an actuator that can move the OIS lens. In a case where there is a movement, such as camera-shake, while photographing, the OIS lens may correct the movement.

The electronic device in FIG. 10B has a gyro sensor 1050 which may detect an angular velocity in response to the movement of the electronic device. Through the angular velocity, the gyro sensor 1050 may detect the number of times that the electronic device moves per second. The gyro sensor 1050 may be included in an image sensing module 1020 or a camera module. Alternatively, the gyro sensor 1050 is included in the electronic device and may be independent of the image sensing module 1020 or the camera module. In the present disclosure, the angular velocity may be detected by the gyro sensor 1050, but the angular velocity at which the electronic device moves may also be detected through various sensors that can detect the movement of the electronic device. The gyro sensor 1050, together with the various sensors, may be included in a sensor unit. The sensor unit may include at least one sensor that detects the state of the electronic device. For example, the sensor unit may include: a proximity sensor that detects whether a user accesses the electronic device; an illumination sensor that detects the amount of light around the electronic device; a motion sensor that detects the motion of the electronic device (e.g., rotation of the electronic device, acceleration or vibration applied to the electronic device, the movement of the electronic device in the up/down direction, the movement of the electronic device in the left/right direction, etc.); a geo-magnetic sensor that detects a point of the compass using the Earth's magnetic field; a gravity sensor that detects the direction in which the gravitational force is applied; and an altimeter that detects an altitude by measuring the atmospheric pressure. At least one sensor may detect the state and may generate a signal corresponding to the detection to transmit the generated signal to a controller. Each sensor of the sensor unit may be added or omitted according to the implementation and desired performance of the electronic device. The sensor unit may detect the direction in which the electronic device moves, and may detect whether the electronic device moves in the opposite direction.

The movement information from the gyro sensor 1050 may be input to a lens drive module 1040. In one embodiment, the lens drive module 1040 moves the OIS lens in response to the movement information from the gyro sensor 1050. For example, when movement information indicating that the electronic device moves in a first direction is input from the gyro sensor 1050, the lens drive module 1040 may move the OIS lens in a second direction opposite to the first direction to correct the movement.

In the various embodiments of the present disclosure, the image sensing module 1020 may output exposure information to the lens drive module 1040. The lens drive module 1040 may add a drive signal for moving the lens in a high-definition mode to a drive signal for correcting a movement and may output the drive signals to the lens module 1010. According to the above description, the various embodiments of the present disclosure may be implemented without the addition of separate hardware by generating an additional drive signal based on exposure information and outputting the generated drive signal to the lens drive module 1040 of the electronic device that has an existing OIS function.

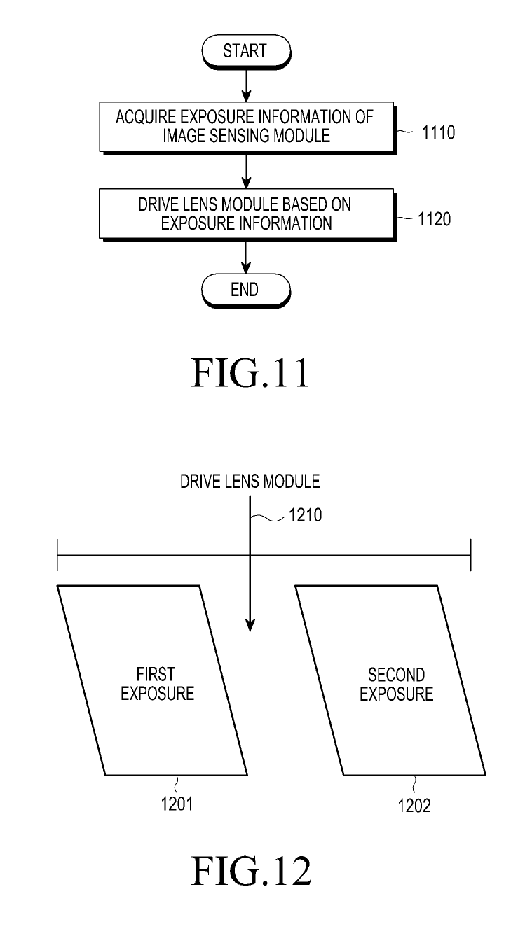

FIG. 11 is a flowchart illustrating a control method of an electronic device, according to various embodiments of the present disclosure.

In step 1110, the electronic device acquires exposure information of an image sensing module. The exposure information may be preset, or may be adjusted by a user's operation. Alternatively, the electronic device may also automatically adjust the exposure information according to the intensity of illumination in the photographing environment.

In step 1120, the electronic device drives a lens module based on the exposure information. For example, referring to FIG. 12, the electronic device may set a period for read between a first exposure period 1201 and a second exposure period 1202. Namely, the electronic device may accumulate electrical charges output from a photodiode for the first exposure period 1201, and may read the electrical charges, which are accumulated for the first exposure period 1201, for the read period. Thereafter, the electronic device may accumulate electrical charges output from the photodiode for the second exposure period 1202.

The electronic device may drive the lens module for the period for read (or read period) between the exposure periods 1201 and 1202 as indicated by reference numeral 1210. Accordingly, the lens moves for the exposure periods so that it is possible to solve the problem that the accumulation of electrical charges is disturbed. Namely, a high-definition image in which a sufficient amount of light is reflected may be acquired by virtue of interworking between the movement of the lens and the exposure/read time of the image sensing module.

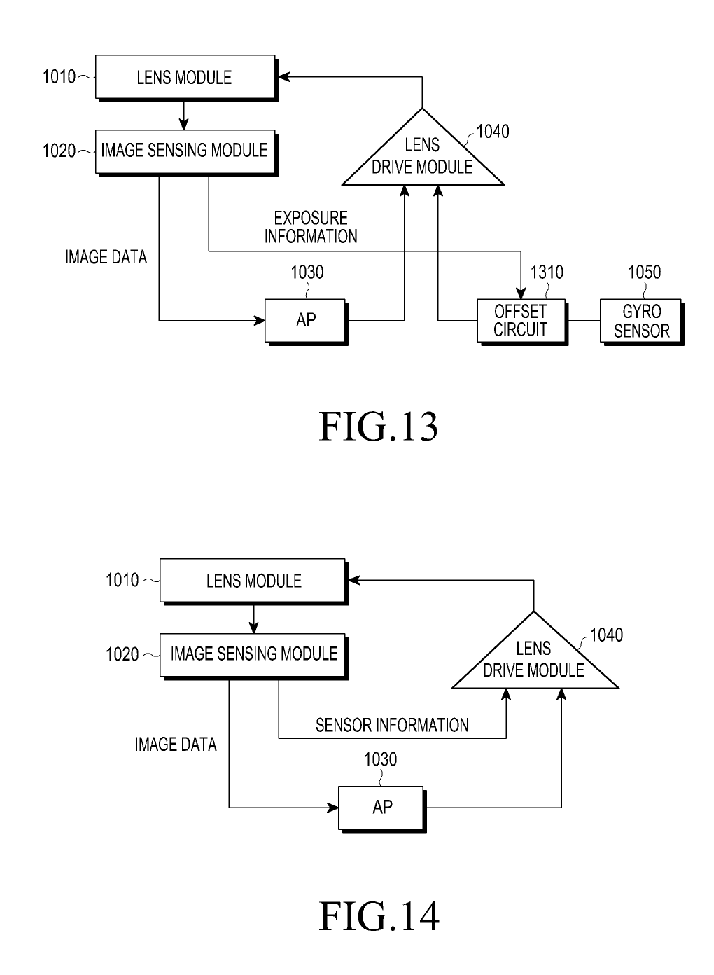

FIG. 13 is a schematic diagram of an electronic device according to various embodiments of the present disclosure. In addition to the components common to FIGS. 10A and 10B, the embodiment of FIG. 13 further includes an offset circuit 1310. The offset circuit 1310 is connected to the gyro sensor 1050 and the lens drive module 1040. An image sensing module 1020 outputs exposure information to the offset circuit 1310. As described above, the gyro sensor 1050 may output movement information of the electronic device. The lens drive module 1040 may add a drive signal for moving a lens in a high-definition mode to a drive signal for correcting the movement and may output the sum of the drive signals to a lens module 1010. In this case, the exposure information of the image sensing module 1020 may be output to the offset circuit 1310 as illustrated in FIG. 13. The offset circuit 1310 may add the drive signal for moving the lens in the high-definition mode to the movement information from the gyro sensor 1050 as an offset and may output the same to the lens drive module 1040. The lens drive module 1040 may drive the lens module 1010 based on the result of the addition from the offset circuit 1310.

FIG. 14 is a schematic diagram of an electronic device according to various embodiments of the present disclosure. In the embodiment of FIG. 14, sensor information of an image sensing module 1020 is output to lens drive module 1040, compared with the embodiment of FIG. 10A. Here, the sensor information may include at least one of the sensitivity and the available frequency of the image sensing module 1020. The sensitivity of the image sensing module 1020 may include sensitivity according to time.

The lens drive module 1040 generates and outputs a drive signal for driving the lens based on one of a linear method and a Pulse Width Modulation (PWM) method. The lens drive module 1040 may determine one of the linear method and the PWM method to use based on the sensor information, which may include, for example, at least one of the sensitivity and the available frequency of the image sensing module 1020. The lens drive module 1040 may determine the drive method to minimize noise generated by the image sensing module 1020.

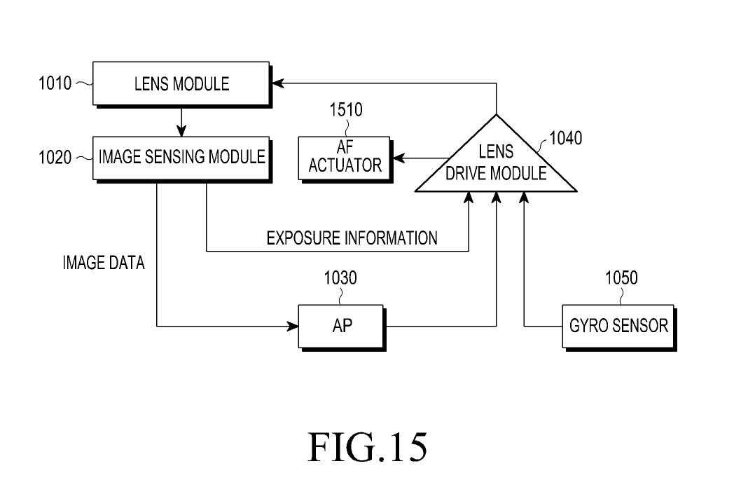

FIG. 15 is a schematic diagram of an electronic device according to various embodiments of the present disclosure. The embodiment of FIG. 15 further includes an Auto Focusing (AF) actuator 1510, compared with the embodiment of FIG. 10B. The AF actuator 1510 drives the lens for an auto-focusing function. In the various embodiments of the present disclosure, the electronic device may move the lens to a plurality of locations by driving the AF actuator 1510 as well as an actuator for OIS.

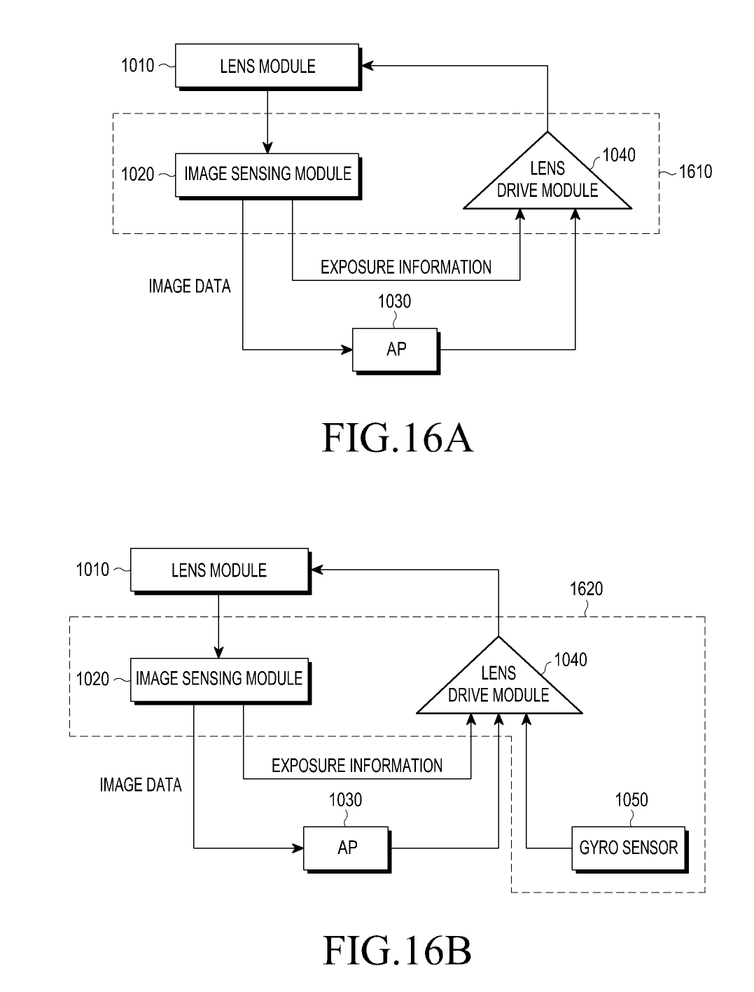

FIGS. 16A and 16B are schematic diagrams of an electronic device according to various embodiments of the present disclosure. In the embodiment of FIG. 16A, an image sensing module 1020 and a lens drive module 1040 are implemented as an image sensor that is a single hardware product. In the embodiment of FIG. 16B, a gyro sensor 1050, together with an image sensing module 1020 and a lens drive module 1040, are implemented as an image sensor that is a single hardware product.

In various embodiments of the present disclosure, an image photographing method of an image sensing module, each pixel of which includes a plurality of photodiodes, may include: disposing a lens at a first location and measuring the first amount of received light using the plurality of photodiodes for a first period; disposing the lens at a second location and measuring the second amount of received light using the plurality of photodiodes for a second period; and creating the image based on the first amount of received light and the second amount of received light.

The resolution of the image may be greater than the number of pixels.

In the various embodiments of the present disclosure, the creating of the image based on the first amount of received light and the second amount of received light may include creating the image by adding data on the first amount of received light and data on the second amount of received light.

In the various embodiments of the present disclosure, the creating of the image based on the first amount of received light and the second amount of received light may include shifting the data on the second amount of received light and creating the image by adding the data on the first amount of received light and the shifted data.

In the various embodiments of the present disclosure, the creating of the image based on the first amount of received light and the second amount of received light may include creating the image based on the first amount of received light and the second amount of received light in a case where at least one of the intensity of illumination in a photographing environment and an indicator relating to the intensity of illumination exceeds a preset threshold value.

In the various embodiments of the present disclosure, the indicator relating to the intensity of illumination may include at least one of exposure information and a gain value of the image sensing module.

In the various embodiments of the present disclosure, the image photographing method may further include moving the lens from the first location to the second location based on at least one of exposure information and sensor information, which are input from the image sensing module.

In the various embodiments of the present disclosure, the moving of the lens from the first location to the second location may include moving the lens for a read period of the image sensing module.

In the various embodiments of the present disclosure, the sensing information may include at least one of the sensitivity and the available frequency of the image sensing module, and the moving of the lens from the first location to the second location may include moving the lens using a linear method, or a Pulse Width Modulation (PWM) method, as an operating method of the lens drive module based on the sensor information.

Each of the components of the electronic device according to the present disclosure may be implemented by one or more components and the name of the corresponding component may vary depending on a type of the electronic device. In various embodiments, the electronic device may include at least one of the above-described elements. Some of the above-described elements may be omitted from the electronic device, or the electronic device may further include additional elements. Further, some of the components of the electronic device according to the various embodiments of the present disclosure may be combined to form a single entity, and thus, may equivalently execute functions of the corresponding elements prior to the combination.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be the smallest unit of an integrated component or a part thereof. The “module” may be the smallest unit that performs one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter.

According to various embodiments, at least some of the devices (for example, modules or functions thereof) or the method (for example, operations) according to the present disclosure may be implemented by a command stored in a non-transitory computer-readable storage medium in a programming module form. When the command is executed by one or more processors (for example, the processor 120), the one or more processors may execute a function corresponding to the command. The non-transitory computer-readable storage medium may be, for example, the memory 130.

The non-transitory computer readable recoding medium may include a hard disk, a floppy disk, magnetic media (e.g., a magnetic tape), optical media (e.g., a Compact Disc Read Only Memory (CD-ROM) and a Digital Versatile Disc (DVD)), magneto-optical media (e.g., a floptical disk), a hardware device (e.g., a Read Only Memory (ROM), a Random Access Memory (RAM), a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

The programming module according to the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added.

According to various embodiments of the present disclosure, in a storage medium that stores instructions, the instructions are configured to allow at least one processor to perform at least one operation when the instructions are executed by the at least one processor, and the at least one operation may include: disposing a lens at a first location and measuring the first amount of received light using the plurality of photodiodes for a first period; disposing the lens at a second location and measuring the second amount of received light using the plurality of photodiodes for a second period; and creating the image based on the first amount of received light and the second amount of received light.

While the present disclosure has been shown and described with reference to certain embodiments thereof, it will be understood by those skilled in the art that various changes in form and details may be made therein without departing from the scope of the present disclosure. Therefore, the scope of the present disclosure should not be defined as being limited to the embodiments, but should be defined by the appended claims and equivalents thereof.

What is claimed is:

1. An electronic device for photographing an image, comprising:
a lens;
an image sensing module that has pixels, each of which comprises a plurality of photodiodes;
a lens drive module that moves the lens from a first location to a second location; and
a processor that creates the image based on a first amount of received light measured by the plurality of photodiodes at the first location and a second amount of received light measured by the plurality of photodiodes at the second location.

2. The electronic device of claim 1, wherein a resolution of the image is greater than a number of pixels in the image sensing module.

3. The electronic device of claim 1, wherein the processor creates the image by adding data on the first amount of received light and data on the second amount of received light.

4. The electronic device of claim 3, wherein the processor shifts the data on the second amount of received light and creates the image by adding the data on the first amount of received light and the shifted data.

5. The electronic device of claim 1, wherein the lens drive module moves the lens based on at least one of exposure information and sensor information that are input from the image sensing module.

6. The electronic device of claim 5, wherein the lens drive module moves the lens for a read period of the image sensing module.

7. The electronic device of claim 5, wherein the sensor information comprises at least one of a sensitivity and an available frequency of the image sensing module, and
wherein the lens drive module determines its operating method to be a linear method or a Pulse Width Modulation (PWM) method, based on the sensor information.

8. The electronic device of claim 1, further comprising:
a gyro sensor that outputs movement information of the electronic device,
wherein the lens drive module drives the lens based on the movement information of the electronic device and a signal for moving the lens.

9. An electronic device for photographing an image, comprising:
a lens;
a lens drive module that shifts the location of the lens;
an image sensing module that has pixels, each of which comprises a plurality of photodiodes; and
a processor that determines the photographing mode of the electronic device to be a high-definition mode or a low-noise mode based on at least one of an intensity of illumination in a photographing environment and an indicator relating to the intensity of illumination.

10. The electronic device of claim 9, wherein the processor determines the photographing mode to be the high-definition mode when the intensity of illumination or the indicator relating to the intensity of illumination exceeds a preset threshold value.

11. The electronic device of claim 10, wherein the lens drive module moves the lens from a first location to a second location, and
wherein the processor creates the image based on a first amount of received light measured by the plurality of photodiodes at the first location and a second amount of received light measured by the plurality of photodiodes at the second location.

12. The electronic device of claim 11, wherein the processor shifts data on the second amount of received light and creates the image by adding data on the first amount of received light and the shifted data.

13. The electronic device of claim 9, wherein the processor determines the photographing mode to be the low-noise mode when the intensity of illumination or the indicator relating to the intensity of illumination is less than or equal to a preset threshold value.

14. The electronic device of claim 13, wherein the lens drive module moves the lens from a first location to a second location, and wherein the method further comprises:
an Analog to Digital Converter (ADC) that simultaneously performs analog-to-digital conversion on a first amount of received light measured by the plurality of photodiodes at the first location and a second amount of received light measured by the plurality of photodiodes at the second location.

15. The electronic device of claim 14, wherein the processor creates the image based on an output from the ADC.

16. The electronic device of claim 9, wherein the lens drive module drives the lens to a first movement when the photographing mode of the electronic device is determined to be the low-noise mode, and drives the lens to a second movement when the photographing mode of the electronic device is determined to be the high-definition mode.

17. An image photographing method of an image sensing module of which each pixel comprises a plurality of photodiodes, comprising:
disposing a lens at a first location and measuring a first amount of received light using the plurality of photodiodes for a first period;
disposing the lens at a second location and measuring a second amount of received light using the plurality of photodiodes for a second period; and
creating the image based on the first amount of received light and the second amount of received light.

18. The image photographing method of claim 17, wherein a resolution of the image is greater than a number of pixels of the image sensing module.

19. The image photographing method of claim 17, wherein creating the image based on the first amount of received light and the second amount of received light comprises:
creating the image by adding data on the first amount of received light and data on the second amount of received light.

20. The image photographing method of claim 17, wherein creating the image based on the first amount of received light and the second amount of received light comprises:
shifting the data on the second amount of received light; and
creating the image by adding the data on the first amount of received light and the shifted data.

21. The image photographing method of claim 17, further comprising:
moving the lens from the first location to the second location based on at least one of exposure information and sensor information that are input from the image sensing module.

22. The image photographing method of claim 21, wherein moving the lens from the first location to the second location comprises:
moving the lens for a read period of the image sensing module.

23. The image photographing method of claim 21, wherein the sensor information comprises at least one of a sensitivity and an available frequency of the image sensing module, and wherein moving the lens from the first location to the second location comprises:
moving the lens using a linear method or a Pulse Width Modulation (PWM) method as an operating method of the lens drive module based on the sensor information.
